(19) United States
(12) Patent Application Publication
(10) Pub. No.: US 2012/0214569 A1
(43) Pub. Date: Aug. 23, 2012

(54) Gaming System, a Method of Controlling a Gaming System and a Controller

(76) Inventors: Sek Hwan Joung, North Rocks NSW (AU); Billy Tam, Marsfield NSW (AU)

(21) Appl. No.: 13/399,363

(22) Filed: Feb. 17, 2012

(30) Foreign Application Priority Data
Feb. 17, 2011 (AU) 2011900539

(51) Int. Cl. A63F 13/12

(52) U.S. Cl. 463/16; 463/42

(57) ABSTRACT

There is provided a gaming system comprising: a plurality of gaming devices, each gaming device having an audio and/or visual output device having a controllable output; and a controller arranged to: monitor a state of each of the plurality of gaming devices; determine that a state of at least one of the gaming devices has changed; and control at least one other gaming device of the plurality of gaming devices to modify the controllable output of each of the at least one other gaming device in response to the change of state.

### RELATED APPLICATIONS

This application claims priority to Australian Provisional Patent Application No. 2011900539 having an International filing date of Feb. 17, 2011, which is incorporated herein by reference.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The present invention relates to a gaming system, a method of controlling a gaming system and a controller.

It is known to connect multiple gaming machines as a gaming system to allow a group of players to participate in a group game. In many of such gaming systems, additional audio or visual output devices are connected to the gaming machines for attracting players to play the gaming machines and to participate in the group game. One arrangement involves connecting the gaming machines to an overhead display that displays the prizes or winnings awarded to the players participating in the group game.

While such gaming systems provide players with enjoyment, a need exists for alternative gaming systems in order to maintain or increase player enjoyment.

### BRIEF SUMMARY OF THE INVENTION

In a first aspect, the invention provides a gaming system comprising:

a plurality of gaming devices, each gaming device having an audio and/or visual output device having a controllable output; and

a controller arranged to:
monitor a state of each of the plurality of gaming devices;
   determine that a state of at least one of the gaming devices has changed; and
   control at least one other gaming device of the plurality of gaming devices to modify the controllable output of each of the at least one other gaming device in response to the change of state.

In an embodiment, the controller is further arranged to, in response to the change of state, modify the controllable output of each gaming device that has changed state.

In an embodiment, the controller is further arranged to:

determine an initial state of each of the plurality of gaming devices; and

determine an initial output of the audio and/or visual output device of each of the plurality of gaming devices.

In an embodiment, the controller modifies the controllable output of each gaming device that is adjacent to a gaming device that has changed state.

In an embodiment, the state of each gaming device is either “occupied” or “not occupied”.

In an embodiment, each gaming device that has changed state changed from a “not occupied” state to an “occupied” state, and wherein the controller modifies the controllable output of each gaming device that is in a “not occupied” state.

In an embodiment, each gaming device that has changed state changed from a “not occupied” state to an “occupied” state, and wherein the controller modifies the controllable output of each gaming device that is in an “occupied” state.

In an embodiment, each audio and/or visual output device is a speaker.

In an embodiment, each audio and/or visual output device is a light-emitting-device.

In an embodiment, each audio and/or visual output device is a speaker and a light-emitting-device.

In an embodiment, the controller modifies the controllable output of each gaming device based on the state of the gaming device.

In an embodiment, the controller reduces the volume of the speaker of each gaming device that is in a “not occupied” state.

In an embodiment, the controller dims the intensity of the light-emitting-device of each gaming device that is in a “not occupied” state.

In an embodiment, each gaming device is adapted to conduct a game, and the controller is further arranged to control at least one gaming device to modify the game conducted on the at least one gaming device in response to the change of state.

In an embodiment, the controller modifies each game by modifying the rules of the game.

In an embodiment, the controller modifies each game by modifying a probability of winning.

In a second aspect, the invention provides a method of controlling a gaming system comprising a plurality of gaming devices, each gaming device having an audio and/or visual output device having a controllable output, the method comprising:

monitoring a state of each of the plurality of gaming devices;

determining that a state of at least one of the gaming devices has changed; and

controlling at least one other gaming device of the plurality of gaming devices to modify the controllable output of each of the at least one other gaming device in response to the change of state.

In an embodiment, the method further comprises modifying the controllable output of each gaming device that has changed state in response to the change of state.

In an embodiment, the method further comprises:

determining an initial state of each of the plurality of gaming devices; and

determining an initial output of the audio and/or visual output device of each of the plurality of gaming devices.

In an embodiment, the controllable output of each gaming device that is adjacent to a gaming device that has changed state is modified.

In an embodiment, the state of each gaming device is either “occupied” or “not occupied”.

In an embodiment, each gaming device that has changed state changed from a “not occupied” state to an “occupied” state, and wherein the controllable output of each gaming device that is in a “not occupied” state is modified.

In an embodiment, each gaming device that has changed state changed from a “not occupied” state to an “occupied” state, and wherein the controllable output of each gaming device that is in an “occupied” state is modified.

In an embodiment, each audio and/or visual output device is a speaker.

In an embodiment, each audio and/or visual output device is a light-emitting-device.

In an embodiment, each audio and/or visual output device is a speaker and a light-emitting-device.

In an embodiment, each modification of the controllable output of a gaming device is based on the state of the gaming device.

In an embodiment, the volume of the speaker of each gaming device that is in a “not occupied” state is reduced.

In an embodiment, the intensity of the light-emitting-device of each gaming device that is in a “not occupied” state is dimmed.

In an embodiment, each gaming device is adapted to conduct a game, and the method further comprises controlling at least one gaming device to modify the game conducted on the at least one gaming device in response to the change of state.

In an embodiment, each modification to a game is a modification to the rules of the game.

In an embodiment, each modification to a game is a modification to a probability of winning.

In a third aspect, the invention provides a controller for controlling a gaming system comprising a plurality of gaming devices, each gaming device having an audio and/or visual output device having a controllable output, the controller comprising:

a device monitor arranged to monitor a state of each of the plurality of gaming devices;

a state determiner arranged to determine that a state of at least one of the gaming devices has changed; and

an output modifier arranged to control at least one other gaming device of the plurality of gaming devices to modify the controllable output of each of the at least one other gaming device in response to the change of state.

In an embodiment, the output modifier is further arranged to, in response to the change of state, modify the controllable output of each gaming device that has changed state.

In an embodiment, the state determiner is further arranged to:

determine an initial state of each of the plurality of gaming devices; and

determine an initial output of the audio and/or visual output device of each of the plurality of gaming devices.

In an embodiment, the output modifier modifies the controllable output of each gaming device that is adjacent to a gaming device that has changed state.

In an embodiment, the state of each gaming device is either “occupied” or “not occupied”.

In an embodiment, each gaming device that has changed state changed from a “not occupied” state to an “occupied” state, and wherein the output modifier modifies the controllable output of each gaming device that is in a “not occupied” state.

In an embodiment, each gaming device that has changed state changed from a “not occupied” state to an “occupied” state, and wherein the output modifier modifies the controllable output of each gaming device that is in an “occupied” state.

In an embodiment, each audio and/or visual output device is a speaker.

In an embodiment, each audio and/or visual output device is a light-emitting-device.

In an embodiment, each audio and/or visual output device is a speaker and a light-emitting-device.

In an embodiment, the output modifier modifies the controllable output of each gaming device based on the state of the gaming device.

In an embodiment, the output modifier reduces the volume of the speaker of each gaming device that is in a “not occupied” state.

In an embodiment, the output modifier dims the intensity of the light-emitting-device of each gaming device that is in a “not occupied” state.

In an embodiment, each gaming device is adapted to conduct a game, and the controller is further comprises a game modifier arranged to control at least one gaming device to modify the game conducted on the at least one gaming device in response to the change of state.

In an embodiment, the game modifier modifies each game by modifying the rules of the game.

In an embodiment, the game modifier modifies each game by modifying a probability of winning.

In a fourth aspect, the invention provides computer program code which when executed implements the above method.

In a fifth aspect, the invention provides a tangible computer readable medium comprising the above program code.

In a sixth aspect, the invention provides a data signal comprising the above program code.

In a seventh aspect, the invention extends to transmitting the above program code.

### BRIEF DESCRIPTION OF SEVERAL VIEWS OF THE DRAWINGS

An exemplary embodiment of the invention will now be described with reference to the accompanying drawings in which:

FIG. 1 is a block diagram of a gaming system;

FIG. 2 is a perspective view of a stand alone gaming machine;

FIG. 3 is a block diagram of the functional components of a gaming machine;

FIG. 4 is a schematic diagram of the functional components of a memory;

FIG. 5 is a schematic diagram of a network gaming system;

FIG. 6 is a functional block diagram of a controller; and

FIG. 7 is a functional block diagram of a gaming device; and

FIG. 8 is a flow chart of an embodiment.

### DETAILED DESCRIPTION OF THE INVENTION

### Overview of Gaming System

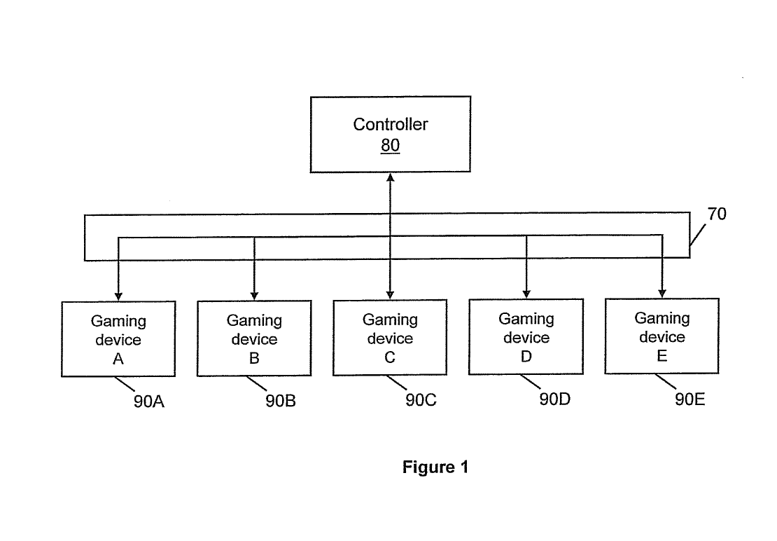

Referring to FIG. 1, there is shown a gaming system comprising a bank of gaming devices 90 and an output controller 80 in data communication over a network 70 with the bank of gaming devices 90. In the gaming system, each of the gaming devices 90 comprises an audio/visual output device having a controllable output. In use, the output controller 80 monitors the bank of gaming devices 90 and determines whether there is a change of state in one or more of the gaming devices 90. If there is a change of state in one or more of the gaming devices 90, the output controller 80 modifies the controllable output of the audio/visual output device of at least one of the other gaming devices 90.

Herein, the term “audio/visual output device” is used to refer to an audio output device, a visual output device, or the combination of an audio output device and a visual output device. Similarly, the term “output controller” is used to refer to an audio output device controller, a visual output device controller, or the combination of an audio output device and a visual output device controller.

General Construction of Gaming Devices

The gaming devices of the gaming system can take any suitable form including stand alone gaming machines and server based gaming terminals.

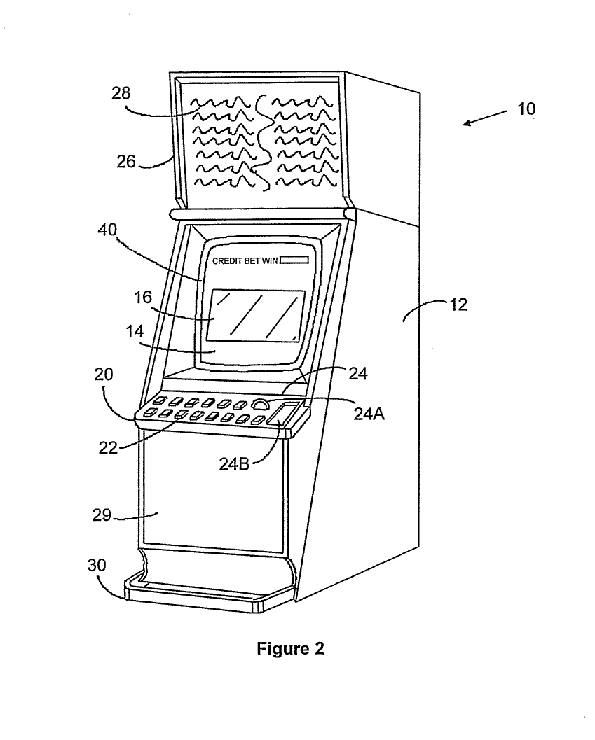

A gaming device in the form of a stand alone gaming machine 10 is illustrated in FIG. 2. The gaming machine 10 includes a console 12 having a display 14 on which are displayed representations of a game 16 that can be played by a player. A mid-trim 20 of the gaming machine 10 houses a bank of buttons 22 for enabling a player to interact with the gaming machine, in particular during game play. The mid-trim 20 also houses a credit input mechanism 24 which in this example includes a coin input chute 24A and a bill collector 24B. Other credit input mechanisms may also be employed, for example, a card reader for reading a smart card, debit card or credit card. Other gaming machines may be configured for ticket in that they have a ticket reader for reading tickets having a value and crediting the player based on the face value of the ticker. A player marketing module (not shown) having a reading device may also be provided for the purpose of reading a player tracking device, for example as part of a loyalty program. The player tracking device may be in the form of a card, flash drive or any other portable storage medium capable of being read by the reading device. In some embodiments, the player marketing module may provide an additional credit mechanism, either by transferring credits to the gaming machine from credits stored on the player tracking device or by transferring credits from a player account in data communication with the player marketing module.

A top box 26 may carry artwork 28, including for example pay tables and details of bonus awards and other information or images relating to the game. Further artwork and/or information may be provided on a front panel 29 of the console 12. A coin tray 30 is mounted beneath the front panel 29 for dispensing cash payouts from the gaming machine 10.

The display 14 shown in FIG. 2 is in the form of a video display unit, particularly a cathode ray tube screen device. Alternatively, the display 14 may be a liquid crystal display, plasma screen, any other suitable video display unit, or the visible portion of an electromechanical device. The top box 26 may also include a display, for example a video display unit, which may be of the same type as the display 14, or of a different type.

The gaming machine 10 has an audio/visual output device 40 in the form of one or more light-emitting devices (LEDs) 40 used to light up the edges of the display 14. The audio/visual output device 40 may alternatively or additionally be a speaker (not shown).

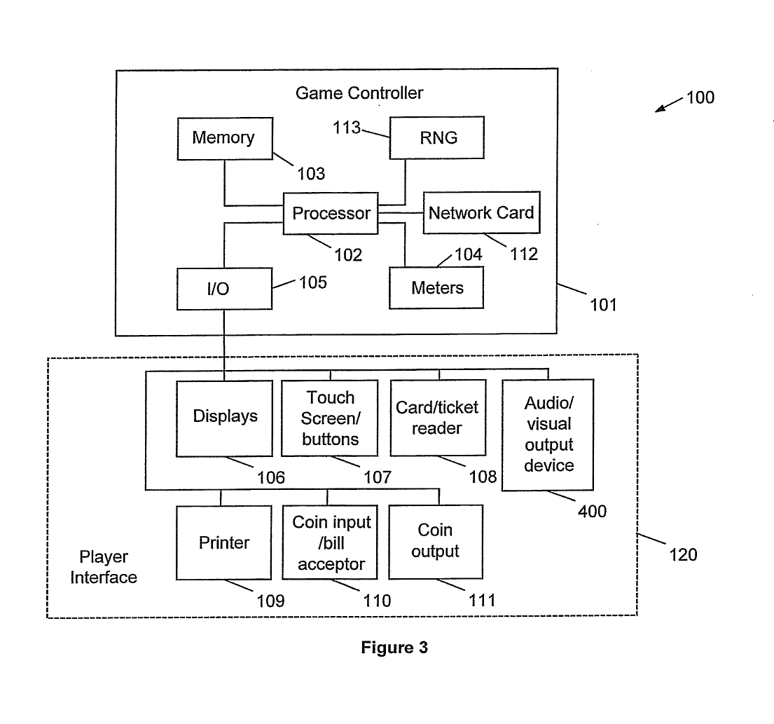

FIG. 3 shows a block diagram of operative components of a typical gaming machine which may be the same as or different to the gaming machine of FIG. 2.

The gaming machine 100 includes a game controller 101 having a processor 102 mounted on a circuit board. Instructions and data to control operation of the processor 102 are stored in a memory 103, which is in data communication with the processor 102. Typically, the gaming machine 100 will include both volatile and non-volatile memory and more than one of each type of memory, with such memories being collectively represented by the memory 103. Herein the term “processor” is used to refer generically to any device that can process game play instructions in accordance with game play rules and may include: a microprocessor, microcontroller, programmable logic device or other computational device, a general purpose computer (e.g. a PC) or a server. That is a processor may be provided by any suitable logic circuitry for receiving inputs, processing them in accordance with instructions stored in memory and generating outputs (for example on the display). Such processors are sometimes also referred to as central processing units (CPUs). Most processors are general purpose units, however, it is also know to provide a specific purpose processor using an application specific integrated circuit (ASIC) or a field programmable gate array (FPGA).

The gaming machine has hardware meters 104 for purposes including ensuring regulatory compliance and monitoring player credit, an input/output (I/O) interface 105 for communicating with peripheral devices of the gaming machine 100. The input/output interface 105 and/or the peripheral devices may be intelligent devices with their own memory for storing associated instructions and data for use with the input/output interface or the peripheral devices. A random number generator module 113 generates random numbers for use by the processor 102. Persons skilled in the art will appreciate that the reference to random numbers includes pseudo-random numbers.

In the example shown in FIG. 3, a player interface 120 includes peripheral devices that communicate with the game controller 101 including one or more displays 106, a touch screen and/or buttons 107 (which provide a game play mechanism), a card and/or ticket reader 108, a printer 109, a bill acceptor and/or coin input mechanism 110, a coin output mechanism 111, and an audio/visual output device 400.

Additional hardware may be included as part of the gaming machine 100, or hardware may be omitted as required for the specific implementation. For example, while buttons or touch screens are typically used in gaming machines to allow a player to place a wager and initiate a play of a game any input device that enables the player to input game play instructions may be used.

In addition, the gaming machine 100 may include a communications interface, for example a network card 112. The network card may, for example, send state information to the output controller 80 to communicate the state of the gaming machine 100 to the output controller 80, and receive data or commands from the output controller 80 to control the audio/visual output device of the gaming machine 100. In embodiments employing a player marketing module, communications over a network may be via player marketing module—i.e. the player marketing module may be in data communication with one or more of the above devices and communicate with it on behalf of the gaming machine.

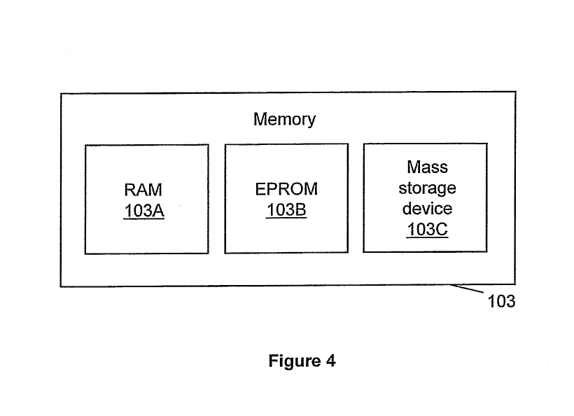

FIG. 4 shows a block diagram of the main components of an exemplary memory 103. The memory 103 includes RAM 103A, EPROM 103B and a mass storage device 103C. The RAM 103A typically temporarily holds program files for execution by the processor 102 and related data. The EPROM 103B may be a boot ROM device and/or may contain some system or game related code. The mass storage device 103C is typically used to store game programs, the integrity of which may be verified and/or authenticated by the processor 102 using protected code from the EPROM 103B or elsewhere.

It is also possible for the operative components of the gaming machine 100 to be distributed, for example input/output devices 106,107,108,109,110,111 to be provided remotely from the game controller 101.

In a client server architecture a gaming device is provided by a gaming client and game server (and optionally other gaming network components). A gaming client has a similar outward appearance to gaming machine 10 but the game server implements most or all of the game and as such acts as the game controller while the terminal operated by the player essentially provides only the player interface. The gaming terminal receives player instructions, pass these to the game server which will process them and return game play outcomes to the gaming machine for display. Further details of a client/server gaming architecture can be found in WO 2006/052213 and PCT/SE2006/000559, the disclosures of which are incorporated herein by reference.

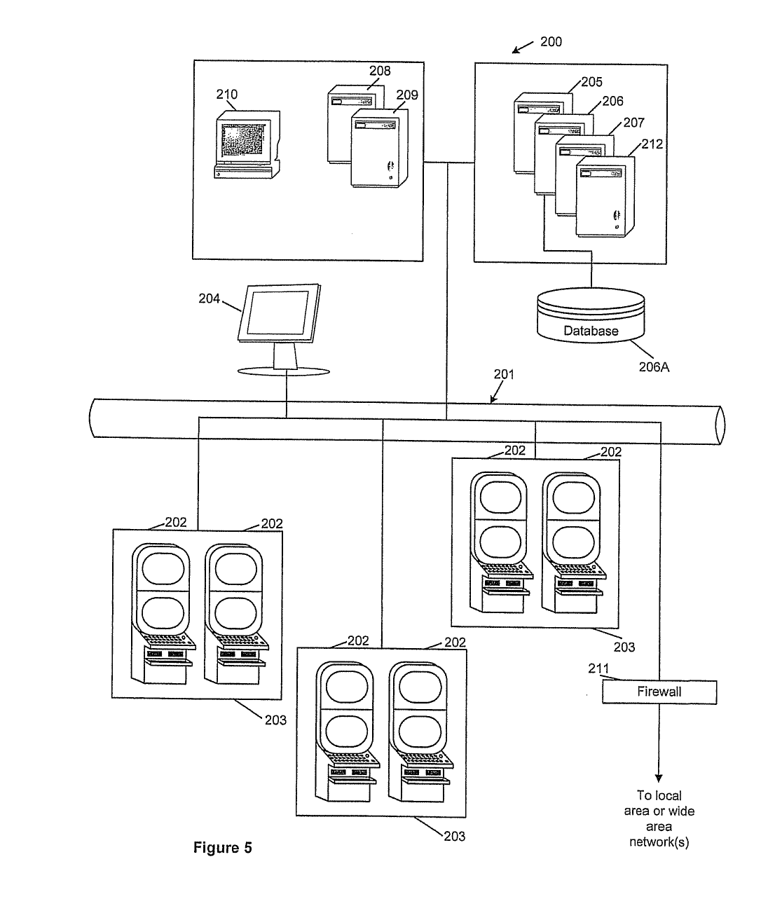

FIG. 5 shows that a gaming device may be connected within a gaming network 200 which provides additional and/or enhanced functionality. The gaming network 200 includes a network 201, which for example may be an Ethernet network. Gaming machines 202, shown arranged in three banks 203 of two gaming machines 202 in FIG. 5, are connected to the network 201. The gaming machines 202 provide a player operable interface and may be the same as the gaming machines 10,100 shown in FIGS. 2 and 3. While banks 203 of two gaming machines are illustrated in FIG. 5, banks of one, three or more gaming machines are also envisaged.

Although not shown in FIG. 5, the gaming machines 202 of each bank 203 may also be in direct data communication with each other. For example, each gaming machine may be directly connected to another gaming machine via an Ethernet network separate from the network 201. In another example, the gaming machines may be connected wirelessly via a wireless local area network (WLAN). In yet another example, there may simply be serial or parallel connections from each gaming machine to all the other gaming machines in the bank.

One or more displays 204 may also be connected to the network 201. For example, the displays 204 may be associated with one or more banks 203 of gaming machines. The displays 204 may be used to display representations associated with game play on the gaming machines 202, and/or used to display other representations, such as promotional or informational material. For example, an overhead display can be arranged above a bank of gaming machines so as to allow all players to easily view the play of others.

An output controller can be provided within the network 200 by an output server 208 that is in data communication with one or more of the banks 203 of gaming machines, such that the output server 208 can control the audio/visual output devices of the gaming machines 202.

A game server 205 may be used to perform some of the processing required for certain games. For example, the game server 205 could run a random number generator engine. Alternatively, a separate random number generator server could be provided. Further, persons skilled in the art will appreciate that a plurality of game servers could be provided to run different games or a single game server may run a plurality of different games as required by the terminals.

A database management server 206 may manage storage of game programs and associated data for downloading or access by the gaming devices 202 in a database 206A. Typically, if the gaming system enables players to participate in a Jackpot game, a Jackpot server 207 will be provided to perform accounting functions for the Jackpot game. A loyalty program server 212 may also be provided.

Servers are also typically provided to assist in the administration of the gaming network 200, including for example a licensing server 209 to monitor the use of licenses relating to particular games. An administrator terminal 210 is provided to allow an administrator to run the network 201 and the devices connected to the network.

The gaming network 200 may communicate with other gaming systems, other local networks, for example a corporate network, and/or a wide area network such as the Internet, for example through a firewall 211.

Persons skilled in the art will appreciate that in accordance with known techniques, functionality at the server side of the network may be distributed over a plurality of different computers. For example, elements may be run as a single “engine” on one server or a separate server may be provided. For example, the game server 205 could run a random generator engine. Alternatively, a separate random number generator server could be provided. Further, persons skilled in the art will appreciate that a plurality of game servers could be provided to run different games or a single game server may run a plurality of different games as required by the terminals.

Further Detail of Gaming Devices

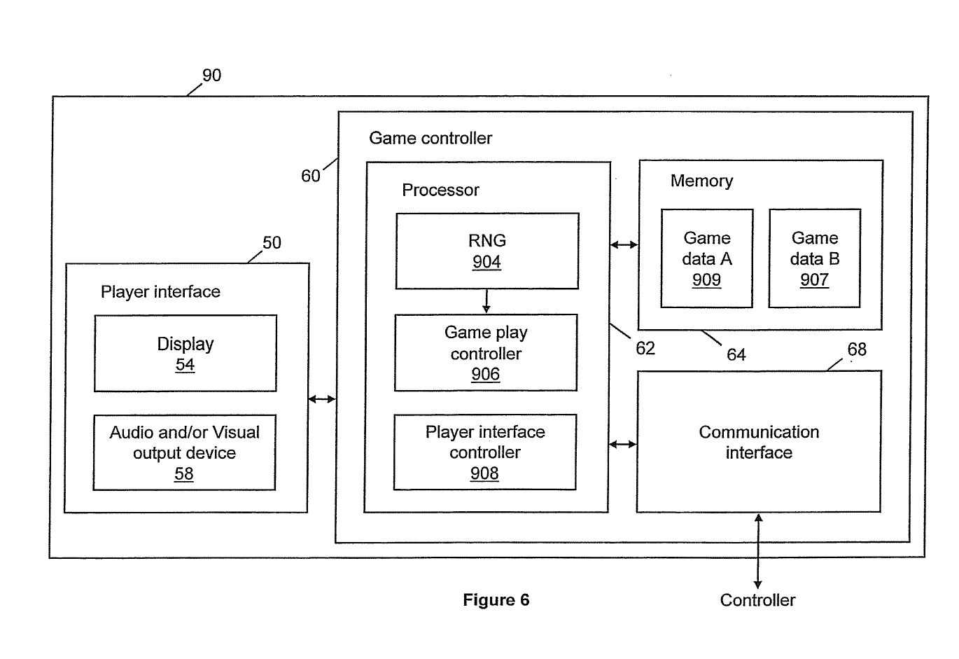

FIG. 6 is a functional block diagram of one of the gaming devices 90 of the gaming system. Persons skilled in the art will appreciate that this figure illustrates only the core components of one possible embodiment of a gaming device 90 of the gaming system and that other embodiments of the gaming device 90 may include alternative or additional components. Persons skilled in the art will also appreciate that one or more of the gaming devices 90 may be different from the other gaming devices 90 of the gaming system.

In this embodiment, the gaming device 90 is in the form of a stand alone gaming machine. The gaming device 90 comprises a player interface 50 and a game controller 60. The game controller 60 comprises a processor 62, memory 64 and a communication interface 68 arranged to send and receive data to the controller 80 of the gaming system.

The player interface 50 comprises a display 54 arranged to display a game to the player and an audio and/or visual output device 58 having a controllable output arranged to provide audio and/or visual output to a player. In one example, the audio and/or visual output device 58 is one or more light emitting devices (LEDs) that are used to light up the edges of the display 54, and the controllable output is the light emitted by the LEDs (the light emitted by the LEDs being controllable in the sense that the intensity or the brightness of the emitted light is controllable). In another example, the audio and/or visual output device 58 is a speaker of the gaming device 90 that is used to play “attract” music or sounds to entice players to play a game in one of the gaming devices 90 of the gaming system, and the controllable output is the sound produced by the speaker (the sound being controllable in the sense that the volume of the speaker is adjustable). In yet another example, the audio and/or visual output device 58 comprises a speaker and a plurality of LEDs, and the controllable output is the sound produced by the speaker and the light emitted by the LEDs.

The processor 62 is shown implementing a number of modules based on program code and data stored in memory 64. Persons skilled in the art will appreciate that the modules are based typically on program code and data stored in memory. Persons skilled in the art will also appreciate that the modules need not be implemented using a processor or be based on program code and data stored in memory and that one or more of the modules could be implemented in some other way, for example, by a dedicated circuit.

The modules implemented by the processor 62 include a player interface controller 908. The player interface controller 908 is arranged to control the operation of the player interface 50 based on communications from the controller 80. Accordingly, the output controller 80 of the gaming system is able to control the gaming device 90 to modify the controllable output of the audio and/or visual output device 58 by communicating with the gaming device 90. For example, in an embodiment, the output controller 80 is able to control the gaming device 90 to modify the intensity or brightness of a LED (that is, to modify the controllable output of the audio and/or visual output device 58) of the gaming device 90 by sending instructions to the player interface controller 908 to decrease the intensity of the light produced by the LED 58.

In addition to the player interface controller 908, the modules implemented by the processor 62 include a game play controller 906. The game play controller 906 is arranged to generate game outcomes for a game playable on the gaming device 90. In this embodiment, the game outcomes are generated based on game data stored in memory 64 and based on random numbers (or pseudo-random numbers) generated by a random number generator (RNG) 904. Persons skilled in the art will appreciate that game data typically includes the rules of the game, the probability of winning, or the award(s) that can be made to a player. In this embodiment, the game data used by the game play controller 906 depends on communications received from the output controller 80. Accordingly, the output controller 80 can control the gaming device 90 to modify the game played on the gaming device 90 by instructing the game play controller 906 of the gaming device 90 to switch from one game data to another game data. For example, the output controller 80 may communicate to the gaming device 90 so that the game play controller 906 of the gaming device 90 switches from using the game rules defined in Game data B 907 stored in memory 64 to the game rules defined in Game data A 909 stored in memory 64 to generate game outcomes. In this embodiment, the game data is stored in memory 64. However, a person skilled in the art will appreciate that, in an alternative embodiment, the game data may not be stored locally in memory but is stored in a remote storage device. Persons skilled in the art will also appreciate that the game played on the gaming device 90 may also be modified in other ways. For example, the game played on the gaming device 90 may be modified by directly modifying the game data stored in the memory 64.

As discussed above, the game controller 60 includes a communication interface 68 to allow the gaming device 90 to communicate with the output controller 80. In particular, the communication interface 68 allows the game play controller 906 and the player interface controller 908 to receive communications from the output controller 80. In FIG. 6, the processor 90 is also shown implementing the RNG 904 which is arranged to generate random numbers or pseudo-random numbers for the game play controller 906 to generate game outcomes.

Persons skilled in the art will appreciate that the gaming device 90 may include other components. For example, the player interface 50 of each gaming device 90 may include a credit mechanism to enable a player to input credits and receive payouts, and a game play mechanism including one or more input devices that enable a player to input game play instructions (e.g. to place a wager).

Output Controller and its Operation within the Gaming System

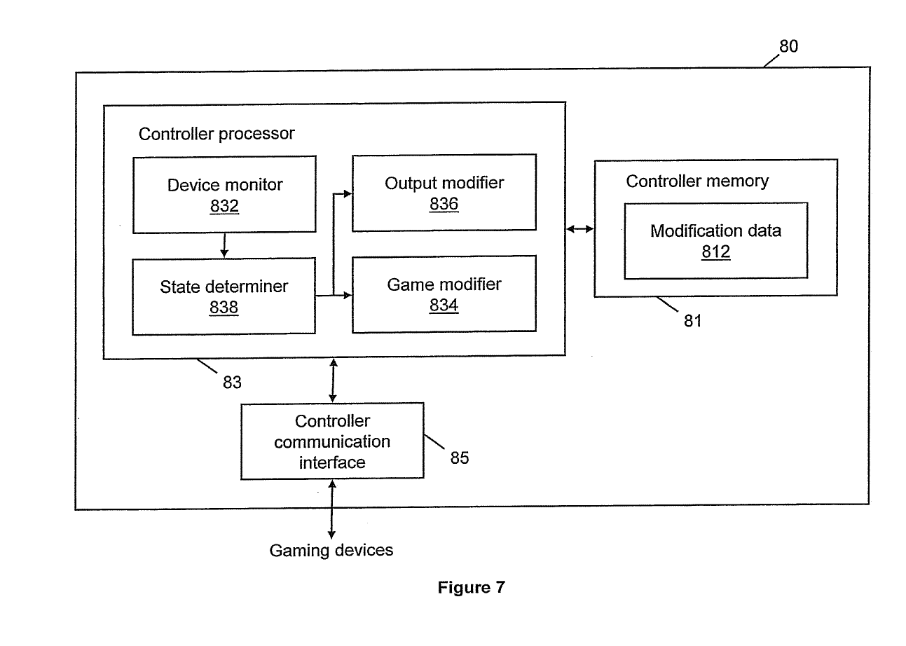

FIG. 7 is a functional block diagram of the output controller 80 of the gaming system. The output controller 80 comprises controller memory 81, a controller processor 83, and a controller communication interface 85 arranged to communicate with the gaming devices 90 of the gaming system. In the figure, the controller processor 83 is shown implementing a number of modules based on program code and data stored in the controller memory 81. Persons skilled in the art will appreciate that one or more of the modules can be implemented in some other way, for example, by a dedicated circuit.

One of the modules implemented by the control processor 83 is the output modifier 836. As will be described in further detail below, the output modifier 836 is arranged to, in response to a change of state in at least one of the gaming devices 90, control at least one or more of the other gaming devices 90 to modify the controllable output or controllable outputs of the other gaming device or devices 90. In this embodiment, the state of each of the gaming devices 90 of the gaming system can be either “occupied” or “not occupied”. Specifically, if there is a player playing a game on a gaming device 90, the state of the gaming device 90 is “occupied”; if a gaming device 90 is idle, the state of the gaming device 90 is “not occupied”.

In this embodiment, the output modifier 836 controls the other gaming devices 90 (that is, the at least one or more of the other gaming devices) to modify the controllable output or controllable outputs of the other gaming devices 90 if there is a change of state from “not occupied” to “occupied” in at least one of the gaming devices 90. To modify the controllable output or controllable outputs, the output modifier 836 generates the instructions for modifying the controllable output or controllable outputs. Thus, instructions for modifying the controllable output or controllable outputs of the other gaming devices 90 are generated only if there is a change of state in one or more of the gaming devices 90 from “not occupied” to “occupied”. In this embodiment, the instructions for modifying the controllable output or controllable outputs are generated by the output modifier 936 only for the gaming devices 90 that are adjacent to a gaming device 90 that has changed from the “not occupied” state to the “occupied” state. Accordingly, whether the controllable output of a gaming device 90 is modified depends on the position of the gaming device 90 relative to the other gaming devices 90 of the gaming system. In other embodiments, the output controller may be alternatively configured such that the generation of the output modification instructions (that is, the instructions for modifying the controllable output or controllable outputs) is not based on the position of a gaming device 90 but on some other condition such as the state of the gaming device 90. For example, in one embodiment, the output controller may be arranged such that output modification instructions are generated for only the gaming device or gaming devices 90 that are in the “occupied” state. It is also envisaged that in yet another embodiment, the generation of modification instructions may be based on a plurality of conditions. For example, whether output modification instructions are generated for a gaming device 90 may depend on both the state of the gaming device 90 and on the position of the gaming device 90 such that output modification instructions are generated by the output modifier 836 for the gaming device 90 only if the gaming device 90 is in a particular state and position.

In this embodiment, the output modifier 836 generates the modification instructions based on modification data 812 stored in memory 81. The modification data 812 sets out the type of modification that is to be applied. For example, if only one of the gaming devices 90 changed from the “not occupied” state to the “occupied” state, the modification instructions may be to reduce the volume of the speaker of each of the adjacent gaming devices 90 (that is, each gaming device that is adjacent to a gaming device that has changed from the “not occupied” state to the “occupied” state) by 10%. However, if two of the gaming devices 90 changed from the “not occupied” state to the “occupied” state, the modification instructions may be to reduce the volume of each of the adjacent gaming devices by 20%. Thus, in this embodiment, the modification instructions generated by the output modifier 936 can vary depending on the number of gaming devices 90 that have changed state.

Another one of the modules implemented by the controller processor 83 is the game modifier 834. In this embodiment, when at least one of the gaming devices 90 changes from the “not occupied” state to the “occupied” state, the game modifier 834 controls at least one of the other gaming devices 90 to modify the game or games of the other gaming devices 90. Thus, in response to a change of state in at least one of the gaming devices 90 from “not occupied” to “occupied”, the game modifier 834 generates instructions for modifying the game or games of at least one of the other gaming devices 90. In this embodiment, the generation of the game modification instructions (that is, the instructions for modifying the game or games) and the generation of the output modification instructions are triggered by the same condition (the condition being that there is change of state in one or more of the gaming devices 90 from “not occupied” to “occupied”). However, it is envisaged that, in an alternative embodiment, the generation of the game modification instructions and the generation of the output modification instructions may be triggered by different conditions. For example, in an alternative embodiment, game modification instructions are generated when there is a change of state in one or more of the gaming devices 90 from “occupied” to “not occupied” (such that the probability of winning of the game of each adjacent gaming device increases when there are less than a number of “occupied” gaming devices) and output modification instructions are generated when there is a change of state in one or more of the gaming devices 90 from “not occupied” to “occupied” (such that the LED of each adjacent gaming device may dim when there are more than a number of “occupied” gaming devices). In this embodiment, the game modifier 834 and the output modifier 836 are arranged to modify the same gaming devices 90 (since both the output modifier 836 and the game modifier 834 are arranged to modify the gaming devices that are adjacent to gaming devices that have changed from a “not occupied” state to an “occupied” state). However, in an alternative embodiment, the gaming devices 90 modified by the game modifier 834 may be different to the gaming devices 90 modified by the output modifier 836.

In this embodiment, the controller processor 83 also implements a device monitor 832 arranged to monitor the states of the gaming devices 90 of the gaming system. During start up, the device monitor 832 determines the initial state of each of the gaming devices 90 and the initial output of the audio and/or visual output device 58 of each of the gaming devices 90. The device monitor 832 then monitors the state of each of the gaming devices 90 by periodically polling each of the gaming devices 90. The controller processor 83 also implements a state determiner 838 arranged to determine that there is a change of state in one or more of the gaming devices 90 from “not occupied” to “occupied” when there is a change of state in the one or more gaming devices 90 from “not occupied” to “occupied”.

In FIG. 7, the output controller 80 also includes a controller communication interface 85 for allowing the output controller 80 to communicate with the gaming device 90. The controller communication interface 85 allows the device monitor 832 to poll each of the gaming devices 90 to monitor the states of the gaming devices 90, and enables the output controller 80 to communicate the output modification instructions generated by the output modifier 836 and the game modification instructions generated by the game modifier 834 to one or more of the gaming devices 90.

In the above gaming system, each of the gaming devices 90 is arranged to allow a player to play only a single player game. However, it is envisaged that each of the gaming devices 90 may be configured to allow a player to play a community game in addition to the single player game. Persons skilled in the art will appreciate that a community game is typically an additional game to the single player game playable on the gaming device 90, and is a group game which can be played by multiple players. Depending on the embodiment, the community game may be based on the single player game or may be a different game to the single player game with different rules.

In the above gaming system, the state of a gaming device 90 depends solely on whether a player is playing a game on the gaming device 90. However, it is envisaged that the state of a gaming device 90 may be based on alternative factors or on multiple factors. For example, the state of a gaming device 90 may be based on whether:

a bet is made within a certain time limit;

one or more of the buttons of the gaming device 90 (for example, the game rules button) is pressed within a certain time limit; and/or

a selection is made by a player.

It is also envisaged that, in an alternative embodiment, there may be three or more states instead of just two states. For example, in one embodiment, each of the gaming devices 90 can be in either a “not occupied” state, a “single player” state”, or a “community game” state.

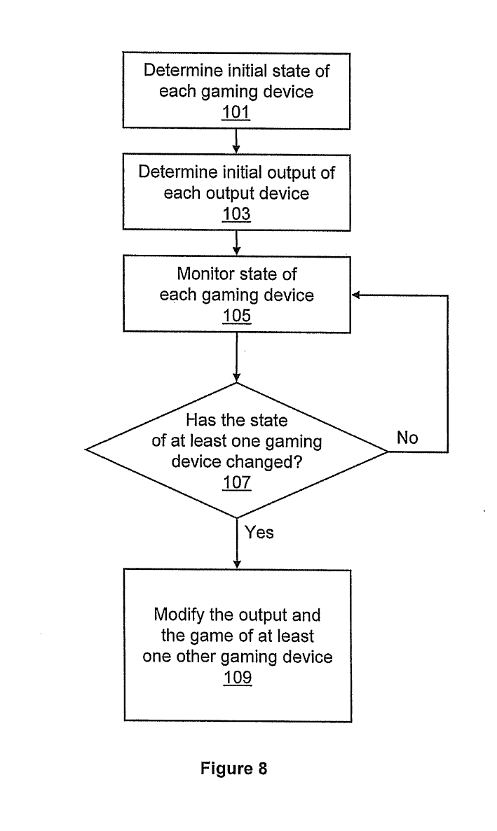

FIG. 8 is a flow chart which summarises a method of controlling the gaming system. The method involves determining the initial state of each of the gaming devices 90 in the gaming system at step 101, and determining the initial output of each of the gaming devices 90 in the gaming system at step 103. In this embodiment, these determinations are carried out by the device monitor 832 of the output controller 80. At step 105, the device monitor 832 monitors the states of the gaming devices 105 by periodically polling each of the gaming devices 90.

At step 107, the state determiner 838 determines whether there is a change of state in one or more of the gaming devices 90 from “not occupied” to “occupied”. If the state determiner 838 determines that none of the gaming devices 90 has changed from a “not occupied” state to an “occupied” state, the output controller 80 waits for the next iteration to poll the gaming devices 90. If the state determiner 838 determines that there is a change of state in one of the gaming devices 90 from “not occupied” to “occupied”, the output modifier 836 of the output controller 80 generates output modification instructions based on modification data 812 stored in memory 81, and the output modification instructions are communicated from the output modifier 836 to the player interface controller 908 of each of the adjacent gaming devices 90 (that is, the gaming devices that are adjacent to the gaming devices 90 that have changed from a “not occupied” state to an “occupied” state) at step 109. At step 109, the game modifier 834 of the output controller 80 also generates game modification instructions based on modification data 812 stored in memory 81, and the game modification instructions are also communicated from the game modifier 934 to the game play controller 908 of each of the adjacent gaming devices 90.

Subsequently, the controllable output of the audio and/or video device 58 of each of the adjacent gaming devices 90 is modified based on the output modification instructions (for example, the volume of the speaker 58 of each of the adjacent gaming devices may be reduced by 10%), and the game of each of the adjacent gaming devices 90 is modified based on the game modification instructions (for example, the game play controller 906 of each of the adjacent gaming devices may change the game rules by using Game data B 907 instead of Game data A stored in memory 909).

Further aspects of the method will be apparent from the above description of the system. It will be appreciated that at least part of the method will be implemented digitally by a processor. Persons skilled in the art will also appreciate that the method could be embodied in program code. The program code could be supplied in a number of ways, for example on a tangible computer readable storage medium, such as a disc or a memory (for example, that could replace part of memory 103) or as a data signal (for example, by transmitting it from a server). Persons skilled in the art, will appreciate that program code provides a series of instructions executable by the processor.

It will be understood to persons skilled in the art of the invention that many modifications may be made without departing from the spirit and scope of the invention, in particular it will be apparent that certain features of embodiments of the invention can be employed to form further embodiments. For example, the output controller 80 is shown in FIG. 1 as a separate entity to the gaming devices 90. In an alternative embodiment, the output controller 80 could be provided by one of the gaming devices 90 incorporating a server module arranged to implement the output controller 80 in the manner described in Australian patent application 2008205413 filed 13 Aug. 2008.

It is to be understood that, if any prior art is referred to herein, such reference does not constitute an admission that the prior art forms a part of the common general knowledge in the art in any country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A gaming system comprising:
a plurality of gaming devices, each gaming device having an audio and/or visual output device having a controllable output; and
a controller arranged to:
monitor a state of each of the plurality of gaming devices;
determine that a state of at least one of the gaming devices has changed; and
control at least one other gaming device of the plurality of gaming devices to modify the controllable output of each of the at least one other gaming device in response to the change of state.

2. A gaming system as claimed in claim 1, wherein the controller is further arranged to, in response to the change of state, modify the controllable output of each gaming device that has changed state.

3. A gaming system as claimed in claim 1, wherein the controller is further arranged to:
determine an initial state of each of the plurality of gaming devices; and
determine an initial output of the audio and/or visual output device of each of the plurality of gaming devices.

4. A gaming system as claimed in claim 1, wherein the controller modifies the controllable output of each gaming device that is adjacent to a gaming device that has changed state.

5. A gaming system as claimed in claim 1, wherein the state of each gaming device is either “occupied” or “not occupied”.

6. A gaming system as claimed in claim 1, wherein each gaming device that has changed state changed from a “not occupied” state to an “occupied” state, and wherein the controller modifies the controllable output of each gaming device that is in a “not occupied” state.

7. A gaming system as claimed in claim 1, wherein each gaming device that has changed state changed from a “not occupied” state to an “occupied” state, and wherein the controller modifies the controllable output of each gaming device that is in an “occupied” state.

8. A gaming system as claimed in claim 1, wherein each audio and/or visual output device is a speaker.

9. A gaming system as claimed in claim 1, wherein each audio and/or visual output device is a light-emitting-device.

10. A gaming system as claimed in claim 1, wherein each audio and/or visual output device is a speaker and a light-emitting-device.

11. A gaming system as claimed in claim 1, wherein the controller modifies the controllable output of each gaming device based on the state of the gaming device.

12. A gaming system as claimed in claim 11 when appended to either claim 8 or claim 10, wherein the controller reduces the volume of the speaker of each gaming device that is in a “not occupied” state.

13. A gaming system as claimed in claim 11 when appended to either claim 9 or claim 10, wherein the controller dims the intensity of the light-emitting-device of each gaming device that is in a “not occupied” state.

14. A gaming system as claimed in claim 1, wherein each gaming device is adapted to conduct a game, and the controller is further arranged to control at least one gaming device to modify the game conducted on the at least one gaming device in response to the change of state.

15. A gaming system as claimed in claim 14, wherein the controller modifies each game by modifying the rules of the game.

16. A gaming system as claimed in claim 14, wherein the controller modifies each game by modifying a probability of winning.

17. A method of controlling a gaming system comprising a plurality of gaming devices, each gaming device having an audio and/or visual output device having a controllable output, the method comprising:
monitoring a state of each of the plurality of gaming devices;
determining that a state of at least one of the gaming devices has changed; and
controlling at least one other gaming device of the plurality of gaming devices to modify the controllable output of each of the at least one other gaming device in response to the change of state.

18. A method as claimed in claim 17, further comprising modifying the controllable output of each gaming device that has changed state in response to the change of state.

19. A method as claimed in either claim 17, further comprising:
determining an initial state of each of the plurality of gaming devices; and
determining an initial output of the audio and/or visual output device of each of the plurality of gaming devices.

20. A method as claimed in claim 17, wherein the controllable output of each gaming device that is adjacent to a gaming device that has changed state is modified.

21. A method as claimed in claim 17, wherein the state of each gaming device is either “occupied” or “not occupied”.

22. A method as claimed in claim 17, wherein each gaming device that has changed state changed from a “not occupied” state to an “occupied” state, and wherein the controllable output of each gaming device that is in a “not occupied” state is modified.

23. A method as claimed in claim 17, wherein each gaming device that has changed state changed from a “not occupied” state to an “occupied” state, and wherein the controllable output of each gaming device that is in an “occupied” state is modified.

24. A method as claimed in claim 17, wherein each audio and/or visual output device is a speaker.

25. A method as claimed in claim 17, wherein each audio and/or visual output device is a light-emitting-device.

26. A method as claimed in claim 17, wherein each audio and/or visual output device is a speaker and a light-emitting-device.

27. A method as claimed in claim 17, wherein each modification of the controllable output of a gaming device is based on the state of the gaming device.

28. A method as claimed in claim 27, wherein the volume of the speaker of each gaming device that is in a “not occupied” state is reduced.

29. A method as claimed in claim 27, wherein the intensity of the light-emitting-device of each gaming device that is in a “not occupied” state is dimmed.

30. A method as claimed in claim 17, wherein each gaming device is adapted to conduct a game, and the method further comprising controlling at least one gaming device to modify the game conducted on the at least one gaming device in response to the change of state.

31. A method as claimed in claim 30, wherein each modification to a game is a modification to the rules of the game.

32. A method as claimed in claim 30, wherein each modification to a game is a modification to a probability of winning.

33. A controller for controlling a gaming system comprising a plurality of gaming devices, each gaming device having an audio and/or visual output device having a controllable output, the controller comprising:
a device monitor arranged to monitor a state of each of the plurality of gaming devices;
a state determiner arranged to determine that a state of at least one of the gaming devices has changed; and
an output modifier arranged to control at least one other gaming device of the plurality of gaming devices to modify the controllable output of each of the at least one other gaming device in response to the change of state.

34. A controller as claimed in claim 33, wherein the output modifier is further arranged to, in response to the change of state, modify the controllable output of each gaming device that has changed state.

35. A controller as claimed in claim 33, wherein the state determiner is further arranged to:
determine an initial state of each of the plurality of gaming devices; and
determine an initial output of the audio and/or visual output device of each of the plurality of gaming devices.

36. A controller as claimed in claim 33, wherein the output modifier modifies the controllable output of each gaming device that is adjacent to a gaming device that has changed state.

37. A controller as claimed in claim 33, wherein the state of each gaming device is either “occupied” or “not occupied”.

38. A controller as claimed in claim 33, wherein each gaming device that has changed state changed from a “not occupied” state to an “occupied” state, and wherein the output modifier modifies the controllable output of each gaming device that is in a “not occupied” state.

39. A controller as claimed in claim 33, wherein each gaming device that has changed state changed from a “not occupied” state to an “occupied” state, and wherein the output modifier modifies the controllable output of each gaming device that is in an “occupied” state.

40. A controller as claimed in claim 33, wherein each audio and/or visual output device is a speaker.

41. A controller as claimed in claim 33, wherein each audio and/or visual output device is a light-emitting-device.

42. A controller as claimed in claim 33, wherein each audio and/or visual output device is a speaker and a light-emitting-device.

43. A controller as claimed in claim 33, wherein the output modifier modifies the controllable output of each gaming device based on the state of the gaming device.

44. A controller as claimed in claim 43, wherein the output modifier reduces the volume of the speaker of each gaming device that is in a “not occupied” state.

45. A controller as claimed in claim 43, wherein the output modifier dims the intensity of the light-emitting-device of each gaming device that is in a “not occupied” state.

46. A controller as claimed in claim 33, wherein each gaming device is adapted to conduct a game, and the controller is further comprises a game modifier arranged to control at least one gaming device to modify the game conducted on the at least one gaming device in response to the change of state.

47. A controller as claimed in claim 46, wherein the game modifier modifies each game by modifying the rules of the game.

48. A controller as claimed in claim 46, wherein the game modifier modifies each game by modifying a probability of winning.

49. A method as claimed in claim 17, further comprising executing a computer program code to implement said monitoring, determining, and controlling.

50. A method as claimed in claim 49, further comprising storing the computer program code in a tangible computer readable medium.

51. A method as claimed in claim 49, further comprising generating data signal comprising the computer program code.

52. A method as claimed in claim 17, further comprising transmitting the computer program code.
